(19) United States
(12) Patent Application Publication
(10) Pub. No.: US 2012/0320125 A1
(43) Pub. Date: Dec. 20, 2012

(54) IMAGE FORMING APPARATUS

(75) Inventors: Tomomi KATOH, Kanagawa (JP); Mitsuya Matsubara, Kanagawa (JP); Soyoung Park, Kanagawa (JP); Honriku Jo, Kanagawa (JP); Yuuji Tanaka, Osaka (JP)

(73) Assignee: RICOH COMPANY, LTD., Tokyo (JP)

(21) Appl. No.: 13/493,050

(22) Filed: Jun. 11, 2012

(30) Foreign Application Priority Data
Jun. 15, 2011 (JP) 2011-133057

(51) Int. Cl. B41J 2/165

(52) U.S. Cl. 347/30

(57) ABSTRACT

An image forming apparatus includes a recording head, a cap, a suction unit, and a recovery device. The recording head has nozzles at a nozzle face to horizontally eject droplets of liquid. The cap caps the nozzle face of the recording head. The suction unit is connected to the cap. The recovery device drives the suction unit with the nozzle face capped with the cap to create a negative pressure in an internal space of the cap and suck the liquid from the recording head. The cap has a contact portion to contact the nozzle face and a suction port to communicate with the suction unit. The suction port is disposed away from the contact portion with a minute gap at a lowermost area of the cap in a vertical direction.

### CROSS-REFERENCE TO RELATED APPLICATION

This patent application is based on and claims priority pursuant to 35 U.S.C. §119 to Japanese Patent Application No. 2011-133057, filed on Jun. 15, 2011, in the Japan Patent Office, the entire disclosure of which is hereby incorporated by reference herein.

### BACKGROUND

1. Technical Field

This disclosure relates to an image forming apparatus, and more specifically to an image forming apparatus using droplets of ink or other liquid to form images.

2. Description of the Related Art

Image forming apparatuses are used as printers, facsimile machines, copiers, or multi-functional devices having two or more of the foregoing capabilities. As one type of image forming apparatus, inkjet recording apparatuses are known that eject droplets of ink or other liquid by a liquid ejection head (recording head) to form desired images. Generally, such inkjet recording apparatuses have a device (hereinafter, “maintenance-and-recovery device”) to maintain and recover the ejection performance of the liquid ejection head.

The maintenance-and-recovery device typically has a cap capable of tightly sealing a nozzle face of the liquid ejection head to prevent the viscosity of ink from increasing due to natural evaporation and viscosity-increased ink from firmly adhering to an area adjacent to nozzles, a suction unit to suck ink from the nozzles with the nozzle face sealed with the cap, a waste-liquid tank to store ink sucked from the nozzles, a wiper blade to wipe and remove ink adhered to the nozzle face, and an ejected ink receptacle to store ink ejected by maintenance ejection (flushing) in which ink droplets not contributing to image formation are ejected for, e.g., preventing clogging of ink in the nozzles.

The maintenance-and-recovery device removes foreign substance and (viscosity-increased) liquid droplets adhered to an adjacent area of the nozzles to maintain desired normal ejection performance of the liquid ejection head.

After printing operation (image forming operation), the cap covers the nozzle face (liquid ejection face) of the liquid ejection head to retain moisture of liquid in the nozzles, thus preventing liquid in the nozzles from drying when the inkjet recording apparatus is not used for a long time.

The suction unit sucks liquid with the nozzle face covered with the cap to create a negative pressure in the cap. As a result, liquid supplied from a liquid tank passes the nozzles and flows into the waste-liquid tank.

At this time, foreign substance adhered to and (viscosity-increased) liquid firmly adhered to an adjacent area of the nozzles can be flown into the waste-liquid tank. In addition, bubbles remaining in a channel from the liquid tank to the nozzles of the liquid ejection head can be discharged.

Conventionally, at a portion of the cap, an air release port and an opening-and-closing unit to open and close the air release port may be provided separately from the channel communicating with the suction unit. In addition, for example, JP-H10-058694-A proposes to provide an ink receiving portion at a lower portion of the cap.

Typically, the liquid ejection head ejects liquid droplets in the gravitational direction to form desired images. By contrast, inkjet recording apparatuses may horizontally eject liquid droplets to form desired images. In addition, for example, JP-2006-192679-A proposes an image forming apparatus having a liquid ejection head inclined relative to the gravitational direction.

For example, in an inkjet recording apparatus that ejects liquid droplets in the gravitational direction, a recording sheet is output with its printed face up (face-up output), thus causing printed sheets to be stacked in a reverse page order. By contrast, the horizontal ejection system is advantageous in that a recording sheet is easily output with its printed face down (face-down output).

The horizontal ejection system also allows liquid ejection heads to be disposed opposing both faces of a recording sheet to simultaneously print both faces of the sheet (for the vertical ejection system, it is necessary to eject liquid droplets upward to form images on a back face of the sheet, thus causing technical difficulties).

However, for the horizontal ejection system, when the cap is retracted (decapped) from the nozzle face after the above-described nozzle suction, ink may drop from a lowermost portion of the cap and soil the lowermost portion of the cap. As a result, ink may accumulate at the lowermost portion of the cap over time, thus causing capping failure.

To cope with such ink dropping, as described above, JP-H10-058694-A proposes to provide the ink receiving portion at a lower portion of the cap. For such a configuration, however, repeated suction of liquid from the liquid ejection head would overflow ink from the ink receiving portion.

### BRIEF SUMMARY

In an aspect of this disclosure, there is provided an image forming apparatus including a recording head, a cap, a suction unit, and a recovery device. The recording head has nozzles at a nozzle face to horizontally eject droplets of liquid. The cap caps the nozzle face of the recording head. The suction unit is connected to the cap. The recovery device drives the suction unit with the nozzle face capped with the cap to create a negative pressure in an internal space of the cap and suck the liquid from the recording head. The cap has a contact portion to contact the nozzle face and a suction port to communicate with the suction unit. The suction port is disposed away from the contact portion with a minute gap at a lowermost area of the cap in a vertical direction.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic partial view of an inkjet recording apparatus serving as an image forming apparatus according to an exemplary embodiment of this disclosure;

FIG. 2 is a schematic view of a maintenance-and-recovery device according to an exemplary embodiment of this disclosure;

FIGS. 3A to 3C are schematic views of operations of a cap and an air release valve according to an exemplary embodiment of this disclosure;

FIG. 4A is a perspective view of a cap according to an exemplary embodiment of this disclosure;

FIG. 4B is an elevation view of the cap of FIG. 4A;

FIG. 4C is a side view of the cap of FIG. 4A;

FIGS. 5A to 5C are schematic views of ink suction states according to an exemplary embodiment of this disclosure;

FIGS. 6A and 6B are schematic views of a rotation mechanism according to an exemplary embodiment of this disclosure to rotate a cap around a lowest point of a contact portion at which the cap contacts a recording head;

FIG. 7A is a perspective view of a variation 1 of the cap;

FIG. 7B is an elevation view of the variation 1 of the cap;

FIG. 7C is a side view of the variation 1 of the cap;

FIG. 8A is a side view of a variation 2 of the cap;

FIG. 8B is an elevation view of the variation 2 of the cap;

FIG. 9A is a side view of a variation 3 of the cap; and

FIG. 9B is an elevation view of the variation 3 of the cap.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION OF EXEMPLARY EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the exemplary embodiments are described with technical limitations with reference to the attached drawings, such description is not intended to limit the scope of the invention and all of the components or elements described in the exemplary embodiments of this disclosure are not necessarily indispensable to the present invention.

Referring now to the drawings, exemplary embodiments of the present disclosure are described below. In the following exemplary embodiments, the same reference characters are allocated to elements (members or components) having the same function and shape and redundant descriptions thereof are omitted below. For sake of simplicity and clearness, elements considered to require no specific descriptions may be omitted from drawings.

First, an image forming apparatus according to an exemplary embodiment is described below.

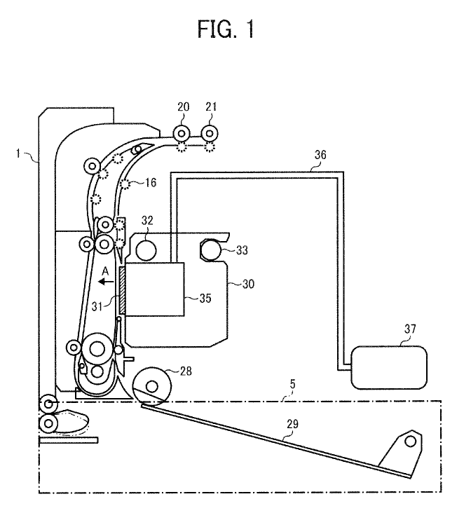

FIG. 1 is a schematic partial view of an inkjet recording apparatus serving as an image forming apparatus according to an exemplary embodiment.

The inkjet recording apparatus has a main guide rod 32 and a sub guide rod 33 to slidably support a carriage 30. A main scanning motor and a timing belt move the carriage 30 for scanning in a longitudinal direction (main scanning direction) of the main guide rod 32 and the sub guide rod 33.

The carriage 33 mounts a recording head 31 for ejecting ink droplets of different colors, e.g., yellow, cyan, magenta, and black so that the recording head 31 is perpendicular to the main scanning direction and parallel to the gravitational direction. In other words, the recording head 31 is mounted on the carriage 30 so as to orient in a direction indicated by an arrow A in FIG. 1.

The recording head 31 may be a thermal-type head to obtain ejection pressure by film boiling of ink, a piezoelectric-type head to obtain ejection pressure by deforming diaphragms by piezoelectric elements, an electrostatic-type head to obtain ejection pressure by deforming diaphragms by electrostatic force, or any other suitable type.

The inkjet recording apparatus conveys a recording sheet upward by a sheet feed roller 28 and sheet output rollers 20 and 21. On the way of conveying the sheet, the inkjet recording apparatus ejects ink droplets from the recording head 31 to the sheet to print (form) a desired image on the sheet.

The recording head 31 is integrally connected to a sub tank 35 including an ink chamber to temporarily store ink. The term “integrally” as used herein represents that the recording head 31 is connected to the sub tank 35 via, e.g., a tube(s) or pipe(s), and both the recording head 31 and the sub tank 35 are mounted on the carriage 30.

One end of a liquid supply tube 36 is connected to the sub tank 35 and the opposite end of the liquid supply tube 36 is connected to an ink cartridge 37 mounted on a body of the inkjet recording apparatus.

In FIG. 1, the ink cartridge 37 is mounted on the body, and ink is supplied from the ink cartridge 37 to the recording head 31 via the liquid supply tube 36. It is to be noted that the configuration of liquid supply is not limited to the above-described configuration but, for example, an on-carriage system may be employed in which the ink cartridge 37 is directly mounted on the recording head 31 to perform printing.

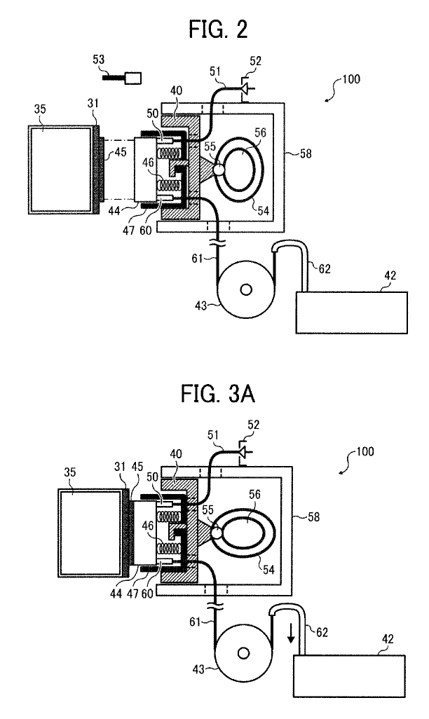

FIG. 2 shows a maintenance-and-recovery device 100 in this exemplary embodiment. In the maintenance-and-recovery device 100 illustrated in FIG. 2, a cap 44 contacts an ink ejection face 45 (nozzle face) of the recording head 31 to retain moisture of and protect nozzles 31n. At a lower portion of the cap 44 is disposed an ink suction port 60 communicating with a suction pump 43 via a suction channel 61.

At an upper portion of the cap 44 is disposed an air release port 50 (air communication port) communicating with an air release channel 51. One end of the air release channel 51 is connected to an air release valve 52.

In this exemplary embodiment, the suction pump 43 serving as a suction unit is a tube pump. However, it is to be noted that the suction pump is not limited to the tube pump but may be any other suitable type of pump. Ink sucked by the suction pump 43 is stored and discarded into a waste-liquid tank 42 through a waste-liquid channel 62.

The cap 44 is held by a cap holder 47, and urging springs 46 are disposed between the cap 44 and the cap holder 47 to closely contact the cap 44 with the ink ejection face 45.

The cap holder 47 is connected to a cap slider 40. The cap slider 40 is fitted in a guide 58. When a cam 56 is rotated by a driving source, the cap 44 is guided in a direction to contact or move away from the ink ejection face 45.

The cam 56 has a rail 54 and a pin 55 movable along the rail 54. As the cam 56 rotates, the distance between the rotational center of the cam 56 and the pin 55 varies and the cap 44 contacts or moves away from the recording head 31.

In this exemplary embodiment, the maintenance-and-recovery device 100 has a wiper blade 53 to wipe the ink ejection face 45. The wiper blade 53 removes foreign substance or ink adhered to the ink ejection face 45 to maintain normal ejection performance of liquid droplets.

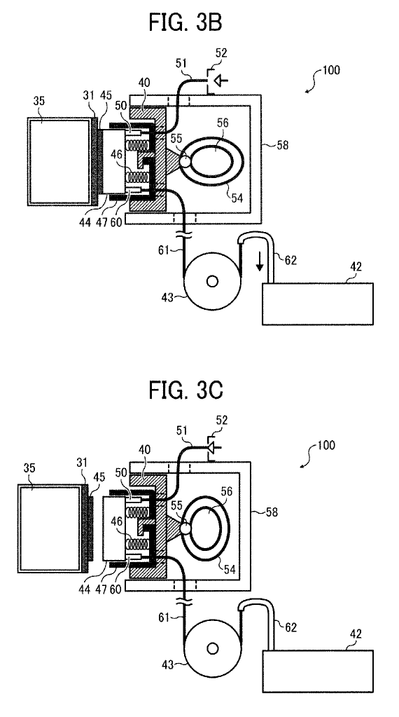

FIGS. 3A to 3C show capping and decapping operations of the cap 44 relative to the ink ejection face 45 and operation of the air release valve 52 in this exemplary embodiment.

FIG. 3A shows a capping state of the cap 44 relative to the ink ejection face 45. In this state, when the suction pump 43 starts suction in a direction toward the waste-liquid tank 42, the pressure within the cap 44 becomes a negative pressure. As a result, ink in the recording head 31 is sucked from the nozzles 31n and flown into the waste-liquid tank 42 via the cap 44 and the suction pump 43.

When the suction pump 43 stops sucking ink from the cap 44, ink in the cap 44 is collected in the gravitational direction to an area proximal to the suction channel 61. At this state, if the cap 44 is retracted from the recording head 31 (FIG. 3C), ink would drop from the cap 44.

To prevent such dropping, as illustrated in FIG. 3B, ink remaining in the cap 44 is sucked with the air release valve 52 open, and then the cap 44 is retracted from the ink ejection face 45.

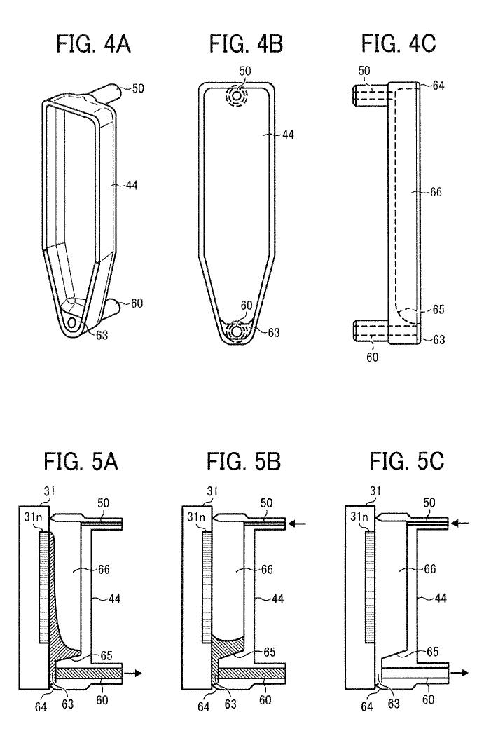

Next, the cap 44 in this exemplary embodiment is described with reference to FIGS. 4A to 4C.

As illustrated in FIGS. 4A and 4B, the width of the cap 44 is relatively narrow at an area proximal to the ink suction port 60.

In addition, the depth of the cap 44 is different between an ink sucking portion 63 and a nozzle opposing portion 66 (see FIG. 4C) that opposes the nozzles 31n of the recording head 31. In other words, a surrounding area of the ink sucking portion 63 is relatively shallow. As illustrated in FIG. 4C, the nozzle opposing portion 66 is smoothly connected to the ink sucking portion 63 via a slope 65.

Next, operation and function of the cap 44 performing suction operation on the recording head 31 are described with reference to FIGS. 3A to 3C and FIGS. 5A to 5C.

FIG. 5A shows a state in which, as in FIG. 3A, with the air release valve 52 closed, the suction pump 43 is driven to create a negative pressure in the cap 44 and suck ink from the recording head 31.

At this time, ink flows from the nozzles 31n due to the negative pressure in the cap 44. Thus, ink is collected to the lower portion of the cap 44 and discharged from the ink suction port 60. The ink sucking portion 63 has a relatively narrow space, thus accelerating the flow speed at which ink is discharged.

Such a high speed ink flow allows effective discharge of viscosity-increased ink or dust accumulated in the lower portion of the cap 44.

After ink suction, the suction pump 43 is stopped and the air release valve 52 is opened. As a result, as illustrated in FIG. 5B, air flows from the air release port 50 into the cap 44, so that the internal pressure of the cap 44 becomes equal to the atmospheric pressure. When such a state is maintained for a certain time, ink adhered to an inner wall surface of the cap 44 and/or the nozzle face of the recording head 31 fall(s) to the lower portion of the cap 44 by gravity.

Then, as illustrated in FIG. 3B, when the suction pump 43 is driven with the air release valve 52 open, ink collected to the lower portion of the cap 44 is discharged from the ink suction port 60 (FIG. 5C).

In this exemplary embodiment, the cap 44 has a minute gap between the ink sucking portion 63 of the cap 44 and the nozzle face of the recording head 31. Such a configuration can increase the flow speed of ink sucked at the ink sucking portion 63, thus increasing ink suction efficiency. Thus, ink in the cap 44 can be discharged without remaining in the cap 44.

As a result, when the suction pump 43 is stopped and the cap 44 is decapped (retracted) from the ink ejection face 45 as illustrated in FIG. 3C, the above-described configuration can prevent ink from dropping from the cap 44.

For the cap 44 in this exemplary embodiment, the depth of the ink sucking portion 63 is equal to the depth of a lip portion (thin portion) of the cap 44 to contact the nozzle face. However, it is to be noted that the depth of the ink sucking portion 63 is not limited to the same depth as the lip portion but may be any other suitable depth.

In the capping state, the gap between the ink sucking portion 63 of the cap 44 and the nozzle face of the recording head 31 is preferably small to an extent that the ink sucking portion 63 is not sealed in contact with the recording head 31. This is because, if the gap is too large, the flow speed of ink at the ink sucking portion 63 may decrease when ink is sucked from the cap 44 with the air release valve open, thus causing insufficient ink discharge.

By contrast, if the nozzle opposing portion 66 as well as the ink sucking portion 63 is shallow, the entire space in the cap 44 would be small, thus increasing fluid resistance in the cap. As a result, when ink is sucked from the nozzles 31n of the recording head 31, pressure gradient would occur in the cap 44.

Specifically, since a smaller negative pressure acts at a position more away from the ink sucking portion 63, the recovery performance of the nozzles 31n may decrease at an upper area in the vertical direction.

In this exemplary embodiment, as illustrated in FIGS. 4A to 4C, the cap 44 has a step formed by the nozzle opposing portion 66 and the ink sucking portion 63. However, since the slope 65 smoothly connects the nozzle opposing portion 66 to the ink sucking portion 63, ink discharged from the nozzles 31n into the cap 44 can be effectively collected to the ink sucking portion 63 via the slope 65.

In addition, as illustrated in FIG. 4B, the width of the cap 44 becomes narrower toward the ink sucking portion 63, thus allowing ink in the cap 44 to be effectively collected to the ink sucking portion 63.

In the above description, operations from nozzle recovery to decapping are performed in the series of processes illustrated in FIGS. 5A, 5B, and 5C. Alternatively, the process of FIG. 5B (to stop the suction pump 43 and open the air release valve 52) may be obviated. In such a case, after nozzle suction of FIG. 5A, the air release valve 52 can be opened without stopping the suction pump 43.

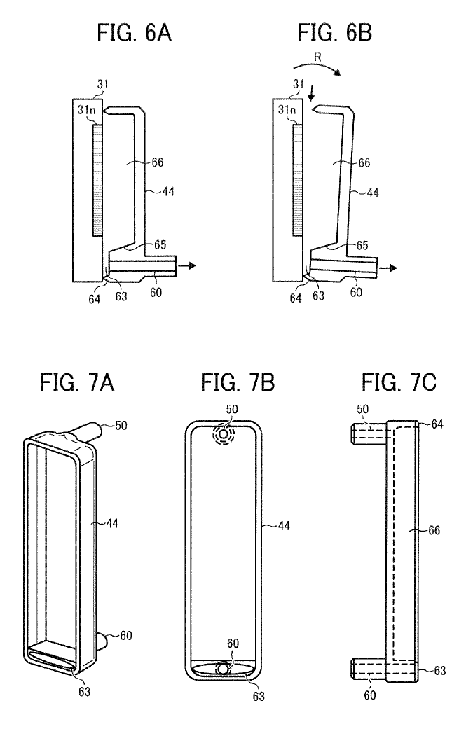

In this exemplary embodiment, the cap 44 has the air release port 50 communicated with the air release channel 51, and the communicated state of the interior of the cap 44 with the atmosphere is controlled by the air release valve 52. Alternatively, after ink is sucked from the nozzles 31n as illustrated in FIG. 6A, as illustrated in FIG. 6B, the cap 44 may be rotated in a direction indicated by an arrow R around a lowest point of a contact portion of the cap 44 at which the cap 44 contacts the recording head 31. Such a configuration allows air to be introduced from an upper portion of the cap 44, thus obviating the air release port or the air release valve of the cap 44.

[Variation 1]

Next, a first variation of the cap 44 in this exemplary embodiment is described with reference to FIGS. 7A to 7C.

FIGS. 7A to 7C are schematic views of the variation 1 of the cap 44.

In FIGS. 7A to 7C, the cap 44 has an opening of a substantially rectangular shape. The ink sucking portion 63 is formed across the entire width of the cap 44 at an area adjacent to a lip 64 serving as a contact portion of the cap 44 to contact the recording head 31.

An ink suction port 60 having a substantially funnel shape is formed at the ink sucking portion 63.

In a case where the cap cannot be tapered toward the ink sucking portion 63 as illustrated in FIGS. 4A to 4C (for example, in a case where a wide-type recording head is employed), as in this variation 1, the ink sucking portion 63 can be formed shallow across the entire width of a lowermost area of the cap 44. Such a configuration can increase the flow speed of ink discharged from the cap 44, thus preventing ink from dropping from the cap 44 when the cap 44 is decapped (retracted) from the recording head 31 like the above-described exemplary embodiment.

[Variation 2]

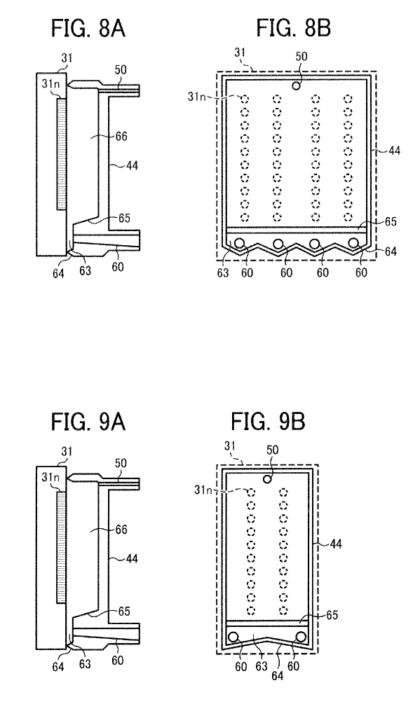

Next, a second variation of the cap 44 in the above-described exemplary embodiment is described with reference to FIGS. 8A and 8B.

FIGS. 8A and 8B are schematic views of the variation 2 of the cap 44.

FIG. 8B is a schematic view of the recording head 31 and the cap 44 seen from an opening side of the cap 44, in which the recording head 31 and the nozzles 31n are indicated by broken lines. In the variation 2, the cap 44 has ink suction ports 60 corresponding to respective nozzle rows of the recording head 31. A lip 64 is formed so as to fence a lower side of each ink suction port 60 in a substantially V-shape, and a surrounding area of each ink suction port 60 is relatively shallow.

When ink is sucked from the nozzles 31n, ink flows down to an area just below the nozzles 31n. Hence, as described above, each ink suction port 60 is disposed at a position just below the nozzles 31n, thus effectively preventing ink from dropping from the nozzles 31n when the cap 44 is decapped from the recording head 31 having multiple nozzle rows.

In the variation example 2, each ink suction port 60 of the cap 44 is a tapered hole whose diameter gradually increases in a direction which ink is discharged, and has a lower portion gradually sloping in the direction which ink is discharged. Such a configuration can reliably prevent ink in the ink suction port 60 from flowing back to the cap 44 when the suction pump 43 is stopped.

[Variation 3]

Next, a third variation of the cap 44 in the above-described exemplary embodiment is described below.

FIGS. 9A and 9B are schematic views of the variation 3 of the cap 44.

FIG. 9B is a schematic view of the cap 44 and the recording head 31 seen from an opening side of the cap 44, in which the recording head 31 and the nozzles 31n are indicated by broken lines. In the variation 3, the cap 44 has ink suction ports 60 at a lower portion of a vertically-extending wall face of the cap 44. A lip 64 is formed so as to fence a lower side of the ink suction port 60 in a substantially V-shape, and a surrounding area of the ink suction ports 60 is relatively shallow.

Ink sucked from the nozzles 31n is likely to remain at corners of the cap 44. Hence, as described above, the ink suction ports 60 are disposed at the lower portion of the vertical wall face of the cap 44, thus effectively preventing ink remaining at corners of the cap 44 from dropping from the cap 44 when the cap 44 is decapped from the recording head 31.

In addition, like the above-described variation 2, in the variation 3, each ink suction port 60 of the cap 44 is a tapered hole whose diameter gradually increases in a direction which ink is discharged, and has a lower portion gradually sloping in the direction which ink is discharged. Such a configuration can reliably prevent ink in the ink suction port 60 from flowing back to the cap 44 when the suction pump 43 is stopped.

As described above, according to at least one of the above-described configurations, the suction port is disposed away from the contact portion, at which the cap 44 contacts the nozzle face of the recording head 31, with a minute gap across the lowermost area of the cap 44. As a result, even when the recording head 31 to horizontally eject liquid droplets is a wide-type recording head, ink accumulated in the lower portion of the cap 44 can be effectively discharged to the outside of the cap 44 by sucking ink from the recording head 31. Thus, the above-described configurations can prevent ink from dropping from the cap 44 when the cap 44 is retracted from the recording head 31 after ink suction.

In addition, according to at least one of the above-described configurations, the cap 44 has a tapered shape in which the width of the cap 44 becomes smaller toward a lower end of the cap 44 in the vertical direction. As a result, ink in the cap 44 can be effectively collected to the ink suction port(s), and ink flowing into the cap by nozzle suction can be effectively collected to the ink suction ports(s) of high flow speed and high suction efficiency, thus preventing ink from remaining in and dropping from the cap 44 when the cap 44 is decapped from the recording head 31.

In addition, according to the above-described configurations, in a state in which the nozzle face of the recording head 31 capped with the cap 44, the cap 44 has a tapered shape at an area below the nozzles 31n in the vertical direction, and the ink suction port(s) of high flow speed and high suction efficiency is (are) disposed at the lowermost portion. Such a configuration enhances ink suction efficiency at an area below the nozzles 31n at which ink is likely to accumulate, thus preventing ink from remaining in and dropping from the cap 44 when the cap 44 is retracted from the recording head 31.

In addition, according to the above-described configurations, the suction ports of high flow speed and high suction efficiency are disposed at corners of the lowermost area of the inner wall face of the cap 44. Such a configuration enhances ink suction efficiency at the corners of the cap 44 in which ink is likely to accumulate, thus preventing ink from remaining in and dropping from the cap 44 when the cap 44 is retracted from the recording head 31.

In addition, according to the above-described configurations, the opposed face of the cap 44 opposing the nozzles 31n of the recording head 31 is connected to the suction port(s) via a slope. As a result, ink sucked from the recording head 31 by nozzle suction can be collected to the suction port(s) of high flow speed and high suction efficiency without remaining in the cap 44. Such a configuration prevents ink from remaining in and dropping from the cap 44 when the cap 44 is retracted from the recording head 31.

In addition, according to the above-described configurations, the suction port(s) of the cap 44 is (are) connected to a liquid discharge channel having a slant face inclined toward a position lower than the suction port(s) in the vertical direction. Such a configuration can prevent ink having flown into the suction port(s) from flowing back to the cap 44, thus preventing ink from remaining in and dropping from the cap 44 when the cap 44 is retracted from the recording head 31.

In addition, according to the above-described configurations, the suction port(s) of the cap 44 that covers the nozzle face of the recording head 31 for horizontally ejecting liquid droplets and sucks liquid from the nozzles of the recording head 31 is (are) disposed, with a minute gap, away from the contact portion of the cap 44 disposed at the lowermost area in the vertical direction to contact the nozzle face of the recording head 31. Additionally, the air release port 50 is provided at the cap 44 so as to be able to communicate the interior of the cap 44 with the atmosphere with the nozzle face of the recording head 31 capped with the cap 44. In this configuration, after ink is sucked from the recording head 31, sucking operation is performed with the interior of the cap 44 communicated with the atmosphere and then the cap 44 is decapped from the nozzle face of the recording head 31. Such configuration and operation can increase the flow speed and suction efficiency of ink at an area surrounding the suction port(s) in ink suction and suck ink without leaving ink in the cap 44, thus preventing dropping of ink from the cap 44 when the cap 44 is retracted from the recording head 31.

Numerous additional modifications and variations are possible in light of the above teachings. It is therefore to be understood that, within the scope of the appended claims, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An image forming apparatus comprising:
a recording head having nozzles at a nozzle face to horizontally eject droplets of liquid;
a cap to cap the nozzle face of the recording head;
a suction unit connected to the cap; and
a recovery device to drive the suction unit with the nozzle face capped with the cap to create a negative pressure in an internal space of the cap and suck the liquid from the recording head,
wherein the cap has a contact portion to contact the nozzle face and a suction port to communicate with the suction unit,
the suction port is disposed away from the contact portion with a minute gap at a lowermost area of the cap in a vertical direction.

2. The image forming apparatus of claim 1, wherein the suction port is provided all over the lowermost area of the cap.

3. The image forming apparatus of claim 1, wherein the cap is tapered so that width of the cap becomes smaller toward a lower end of the cap in the vertical direction.

4. The image forming apparatus of claim 1, wherein, in a state in which the nozzle face is capped with the cap, the cap has a tapered portion at an area corresponding to an area of the nozzle face vertically below the nozzles and has the suction port at a tip of the tapered portion.

5. The image forming apparatus of claim 1, wherein the cap has an inner wall face extending in the vertical direction and the suction port is provided at a corner of a lowermost portion of the inner wall face of the cap.

6. The image forming apparatus of claim 1, wherein an opposing face of the cap opposing the nozzles of the recording head is connected to the suction port via a slope.

7. The image forming apparatus of claim 1, wherein the suction port has a liquid discharge channel having a slant face inclined toward a position lower than the suction port in the vertical direction.

8. The image forming apparatus of claim 1, wherein the cap has an air communication port to be able to communicate the internal space of the cap with atmosphere with the nozzle face of the recording head capped with the cap, and
after the suction unit is driven to suck the liquid from the recording head with the nozzle face of the recording head capped with the cap, the suction unit performs suction operation with the air communication port communicated with the atmosphere and then the cap is detached from the nozzle face.
